(19) United States
(12) Patent Application Publication
(10) Pub. No.: US 2008/0001528 A1
(43) Pub. Date: Jan. 3, 2008

(54) Color conversion substrate and color display

(75) Inventor: Mitsuru Eida, Sodegaura-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Idemitsu Kosan Co., Ltd., Chiyoda-ku (JP)

(21) Appl. No.: 11/488,724

(22) Filed: Jul. 19, 2006

(30) Foreign Application Priority Data
Jun. 29, 2006 (JP) 2006-179223

(51) Int. Cl. H01J 1/62; H01J 63/04

(52) U.S. Cl. 313/501; 313/506; 313/110

(57) ABSTRACT

A color conversion substrate including a transparent substrate; and a plurality of blue color filter layers and a plurality of fluorescence conversion layers provided on the transparent substrate; part of the blue color filter layers separating the fluorescence conversion layers.

### TECHNICAL FIELD

The invention relates to a color conversion substrate, a method for producing the same, and an color display using the same. In particular, the invention relates to a color conversion substrate wherein a blue color filter layer separates a fluorescent conversion layer.

### TECHNICAL BACKGROUND

A technology (color conversion system) has been disclosed which converts light emitted from a blue emitting device into green light and red light using fluorescent conversion layers to emit light of blue, green, and red (i.e. three primary colors), thereby achieving a full color display (patent documents 1 to 3).

A full color display can be obtained using the color conversion system by combining a single-color blue emitting device and a color conversion substrate comprising a blue color filter layer, green fluorescent conversion layer and red fluorescent conversion layer. Note that the blue color filter layer is used for enhancing a chromatic purity of light from the blue emitting device.

According to the above system, since the single-color emitting device can be formed without the need of selectively applying an emitting material, this allows utilization of a small film forming device and reduces the amount of emitting material used. Since the color conversion substrate can be formed by utilizing widely-used photolithography, printing, or the like, a large-screen high-resolution display can be easily mass-produced.

There is also a system (CF method) which achieves a full color display by combining a white emitting device and a color filter. The color conversion system has an advantage in that a stable emitting device can be used in comparison with the CF system. Moreover, the color conversion system achieves high efficiency due to utilization of fluorescence.

Patent document 3 discloses a color conversion member (color conversion substrate) in which a blue color filter layer, a green fluorescence conversion layer, and a red fluorescence conversion layer are embedded between shielding layers.

However, since the patterning accuracy of the thick shielding layer is low, only a rough pattern (aspect ratio (thickness/width)=½) can be formed. Therefore, it is difficult to obtain a high-definition color conversion substrate and a high-definition color display.

In patent documents 4 and 5, a fluorescence conversion layer is embedded between transparent partition walls using an inkjet method or a screen printing method.

However, since the partition wall is transparent, isotropic fluorescence from the fluorescence conversion layer enters the adjacent fluorescence conversion layer through the side surface of the partition wall to excite the adjacent fluorescence conversion layer, whereby unnecessary fluorescence is emitted. This causes the colors to be mixed, whereby a color display with high color reproducibility is hindered.

Moreover, since it is necessary to additionally form the transparent partition wall, the manufacturing cost of the color conversion substrate is increased.

Patent document 6 discloses a color conversion member (color conversion substrate) in which a red color filter is formed between fluorescence conversion layers.

However, since isotropic red fluorescence from the red fluorescence conversion layer passes through the red color filter and enters the green fluorescence conversion layer, a color display with excellent color reproducibility cannot be obtained due to color mixture.

Moreover, since the thickness of the red color filter under the red fluorescence conversion layer is nonuniform, a highly uniform color display may not be obtained.

In addition, the necessity of the polishing step increases the manufacturing cost of the color conversion substrate.

### [Patent document 1] JP-A-3-152897

### [Patent document 2] JP-A-5-258860

### [Patent document 3] WO1998/34437

### [Patent document 4] JP-A-2003-229260

### [Patent document 5] WO2006/022123

### [Patent document 6] JP-A-2004-152749

The invention was achieved in view of the above-described problems. An object of the invention is to provide a high-resolution color conversion substrate and a color display which exhibits excellent color reproducibility.

Another object of the invention is to provide a method for producing a color conversion substrate at a low cost.

### DISCLOSURE OF THE INVENTION

According to the invention, a color conversion substrate, a method for producing the same, and a color display given below are provided.

1. A color conversion substrate comprising: a transparent substrate; and a plurality of blue color filter layers and a plurality of fluorescence conversion layers provided on the transparent substrate; part of the blue color filter layers separating the fluorescence conversion layers.

### 2. The color conversion substrate according to 1, wherein the fluorescence conversion layers include a green fluorescence conversion layer and a red fluorescence conversion layer.

3. The color conversion substrate according to 1 or 2, wherein the blue color filter layer which separates the fluorescence conversion layers has a light transmittance between the fluorescence conversion layers at a wavelength of 500 nm or more of 50% or less.

### 4. The color conversion substrate according to any one of 1 to 3, wherein black matrixes are provided between the blue color filter layers and the fluorescence conversion layers.

5. The color conversion substrate according to any one of 1 to 4, comprising, between the fluorescence conversion layers and the transparent substrate, color filters which block excitation light for the fluorescence conversion layers and transmit fluorescence from the fluorescence conversion layers.

### 6. The color conversion substrate according to any one of 1 to 5, wherein the fluorescence conversion layers include a fluorescent nanocrystal.

### 7. The color conversion substrate according to 6, wherein the fluorescent nanocrystal is a semiconductor nanocrystal.

8. A color display comprising: the color conversion substrate according to any one of 1 to 7; and an emitting device substrate facing the color conversion substrate and emitting a blue light component.
9. A color display comprising: the color conversion substrate according to any one of 1 to 7; and emitting devices facing a blue color filter layer and the fluorescence conversion layers of the color conversion substrate and emitting a blue light component.
10. A color display comprising on a substrate at least a first pixel in which a first emitting device and a blue color filter layer are formed in that order, a second pixel in which a second emitting device and a first fluorescence conversion layer are formed in that order, and a third pixel in which a third emitting device and a second fluorescence conversion layer are formed in that order, the first fluorescence conversion layer and the second fluorescence conversion layer being separated by a blue color filter layer.

### 11. The color display according to any one of 8 to 10, wherein emitting devices are actively driven.

12. A method of producing the color conversion substrate according to any one of 1 to 7, the method comprising:

forming a plurality of blue color filter layers on a transparent substrate; and

selectively forming a plurality of fluorescence conversion layers between the blue color filter layers using a printing method.

### 13. The method according to 12, wherein the printing method is a screen printing method, an inkjet method, or a nozzle jet method.

According to the invention, there can be provided a high-resolution color conversion substrate and a color display which exhibits excellent color reproducibility.

According to the invention, there can be provided a method for producing a color conversion substrate at a low cost.

### BRIEF DESCRIPTION OF THE DRAWINGS

FIG. 1 is a schematic sectional view showing a color conversion substrate according to one embodiment of the invention.

FIG. 2 is a schematic sectional view showing a color conversion substrate according to another embodiment of the invention.

FIG. 3 is a schematic sectional view showing a color conversion substrate according to still another embodiment of the invention.

FIG. 4 is a schematic sectional view showing a color display according to one embodiment of the invention.

FIG. 5 is a schematic sectional view showing a color display according to another embodiment of the invention.

FIG. 6 is a schematic sectional view showing a color display according to still another embodiment of the invention.

FIG. 7 is a view showing steps of forming a polysilicon TFT.

FIG. 8 is a circuit diagram showing an electric switch connection structure-including a polysilicon TFT.

FIG. 9 is a planar perspective view showing an electric switch connection structure including a polysilicon TFT.

### BEST MODE FOR CARRYING OUT THE INVENTION

The color conversion substrate and the color display according to the invention are described below with reference to the drawings. In the drawings, the same members are indicated by the same symbols. Description of these members is appropriately omitted.

### First Embodiment

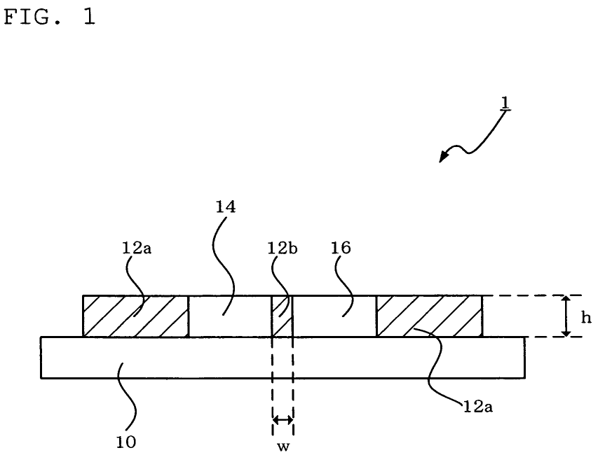

FIG. 1 is a schematic cross-sectional view showing one embodiment of the color conversion substrate according to the invention.

A color conversion substrate 1 includes blue color filter layers 12a and 12b, a green fluorescence conversion layer 14, and a red fluorescence conversion layer 16 on a transparent substrate 10. The blue color filter layer 12b separates the green fluorescence conversion layer 14 and the red fluorescence conversion layer 16. The blue color filter layer 12a may form a blue pixel, the green fluorescence conversion layer 14 may form a green pixel, and the red fluorescence conversion layer may form a red pixel. In FIG. 1, h indicates the thickness of the blue color filter layers 12a and 12b, and w indicates the width of the blue color filter layer 12b which separates the fluorescence conversion layers. FIG. 1 illustrates one green fluorescence conversion layer 14 and one red fluorescence conversion layer 16. Note that the blue color filter layer 12a, the green fluorescence conversion layer 14, the blue color filter layer 12b, and the red fluorescence conversion layer 16 may be repeatedly formed in a pattern. This also applies to other drawings.

For example, when using a blue emitting device as an emitting device (not shown), blue light from the emitting device passes through the blue color filter layer (blue pixel), whereby blue light with a higher chromatic purity can be obtained. The green fluorescence conversion layer (green pixel) absorbs blue light from the emitting device and emits green fluorescence. Likewise, the red fluorescence conversion layer (red pixel) absorbs blue light from the emitting device and emits red fluorescence.

In this embodiment, since the blue color filter layer 12b separates the green fluorescence conversion layer 14 and the red fluorescence conversion layer 16, isotropic green fluorescence from the green fluorescence conversion layer 14 and isotropic red fluorescence from the red fluorescence conversion layer 16 are blocked by the blue color filter layer 12 and prevented from being mixed into the adjacent fluorescence conversion layer and exciting the adjacent fluorescence conversion layer.

Since the blue color filter layer 12a is not a fluorescent layer, the blue color filter layer 12a does not isotropically emit light. Therefore, blue light which passes through the blue color filter layer 12a is mixed to only a small extent into the green conversion layer 14 and the red conversion layer 16 adjacent to the blue color filter layer 12a. This allows the pure three primary colors to be displayed, whereby a full-color display with excellent color reproducibility can be achieved when forming a color display.

Since the blue color filter layers 12a and 12b according to this embodiment transmit a large amount of light in a UV region (300 to 400 nm) in comparison with a black shielding layer (black matrix), the blue color filter layers 12a and 12b are easily patterned by photolithography. Therefore, thicker (h is larger) and more minute (w is smaller) blue color filter layers 12a and 12b can be formed.

Since the fluorescence conversion layers 14 and 16 can be separated by such a minute blue color filter layer 12b, a high-definition color conversion substrate and color display can be obtained.

In the invention, a plurality of blue color filter layers 12a and 12b including the layer 12b (also called partition wall or bank) which separates the fluorescence conversion layers 14 and 16 can be formed at the same time by one layer formation step. Therefore, the step of forming the color conversion substrate is simplified, whereby the manufacturing cost can be reduced.

This embodiment illustrates the case where a blue emitting device is used as the emitting device and the color conversion member is formed of the blue color filter layer, the green fluorescence conversion layer, and the red fluorescence conversion layer. It is also possible to use a blue emitting device and form a color conversion member using a blue color filter layer, a yellow fluorescence conversion layer, and a magenta fluorescence conversion layer. The blue emitting device may include not only a blue component, but also components of other colors such as a green component.

### Second Embodiment

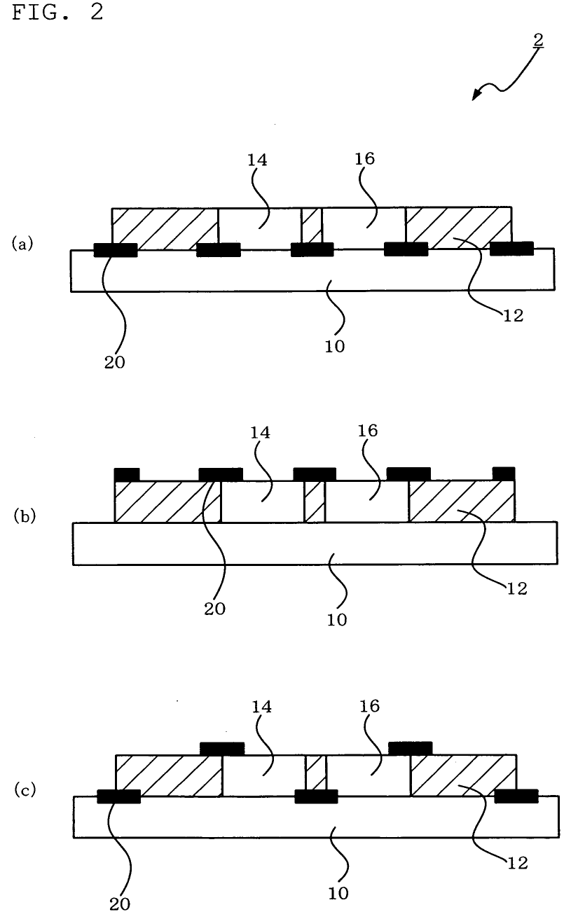

FIG. 2 is a schematic cross-sectional view showing another embodiment of the color conversion substrate according to the invention.

In a color conversion substrate 2, black matrixes 20 are respectively provided between the blue color filter layer 12a, the green fluorescence conversion layer 14, and the red fluorescence conversion layer 16 in the above-described color conversion substrate 1 according to the first embodiment. Since incidence and reflection of external light can be reduced by forming the black matrixes 20, visibility such as contrast and viewing angle characteristics can be improved when forming a color display. As the black matrix 20, a black matrix having a small thickness while maintaining light-shielding properties is preferable.

It suffices that the black matrixes 20 be respectively provided between the blue color filter layer 12a, the green fluorescence conversion layer 14, and the red fluorescence conversion layer 16. The black matrixes 20 may be formed on the transparent substrate 10, as shown in FIG. 2(a), or may be formed on the opposite side of the transparent substrate 10, as shown in FIG. 2(b). As shown in FIG. 2(c), the black matrixes 20 may be alternately formed on the transparent substrate 10 and the opposite side of the transparent substrate 10.

### Third Embodiment

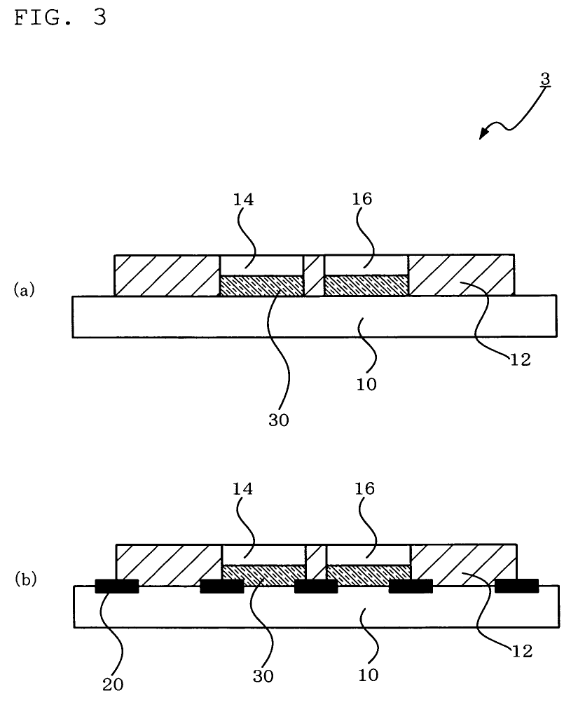

FIG. 3 is a schematic cross-sectional view showing yet another embodiment of the color conversion substrate according to the invention.

In a color conversion substrate 3, as shown in FIG. 3(a), color filters 30 are respectively formed between the green fluorescence conversion layer 14 and the transparent substrate 10 and between the red fluorescence conversion layer 16 and the transparent substrate 12 in the above-described color conversion substrate 1 according to the first embodiment. Since luminescence of the fluorescence conversion layers 14 and 16 due to external light can be reduced by forming the color filter 30, contrast is increased when forming a color display. Moreover, the chromatic purity of fluorescence emitted from the fluorescence conversion layers 14 and 16 and outcoupled to the outside can be improved. As shown in FIG. 3(b), the black matrixes 20 may be additionally formed.

### Fourth Embodiment

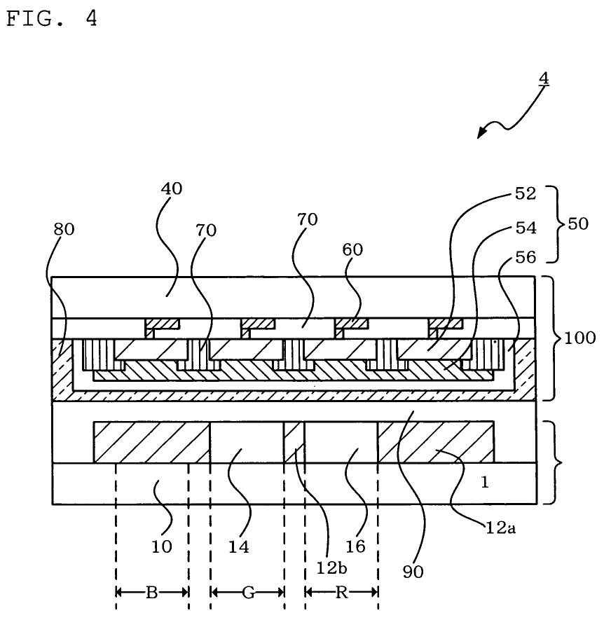

FIG. 4 is a schematic cross-sectional view showing one embodiment of the color display according to the invention.

A color display 4 includes an emitting device substrate 100 in which emitting devices 50 are formed on a supporting substrate 40, and the color conversion substrate 1 according to the first embodiment. The emitting device substrate 100 and the color conversion substrate 1 are disposed so that the emitting devices 50 face the blue color filter layers 12a, the green fluorescence conversion layers 14, and the red fluorescence conversion layers 16.

In more detail, the emitting device substrate 100 includes a thin film transistor (TFT) 60, an inter-insulator 70, a lower electrode 52, a luminescent medium 54, an upper electrode 56, and a barrier film 80 formed in that order on the supporting substrate 40. An emitting device 50 is formed of a lower electrode 52, a luminescent medium 54, and an upper electrode 56.

The emitting device substrate 100 and the color conversion substrate 1 are bonded and sealed using an adhesive layer 90.

In the color display 4, an emitting device 50 and a blue color filter layer 12a opposite thereto form a blue pixel, an emitting device 50 and a green fluorescence conversion layer 14 opposite thereto form a green pixel, and an emitting device 50 and a red fluorescence conversion layer 16 opposite thereto form a red pixel. In this embodiment, the same emitting device is used for the blue, green, and red pixels. Note that different emitting devices may be used for each pixel, as required.

In the top emission type color display according to this embodiment, effects of the color conversion substrate 1 (unevenness of the substrate surface and water/monomer from the color conversion substrate) above the emitting device 50 can be reduced.

In the top emission type color display, since the TFTs 60 are disposed on the supporting substrate 40 opposite to the light-outcoupling side (color conversion substrate 1), the TFTs 60 can be easily disposed, whereby the aperture ratio can be increased. Therefore, the luminance of the color display 4 can be increased.

### Fifth Embodiment

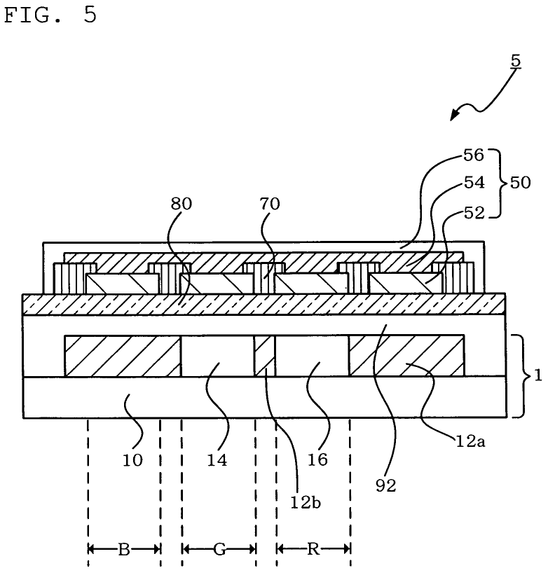

FIG. 5 is a schematic cross-sectional view showing another embodiment of the color display according to the invention.

In a color display 5, a flattening layer 92, the barrier layer 80, the lower electrode 52, the inter-insulator 70, the luminescent medium 54, and the upper electrode 56 are formed in that order on the color conversion substrate 1.

In the bottom emission type color display according to this embodiment, the emitting devices 50 and the color conversion substrate 1 are easily positioned. Moreover, since only one substrate is used, the thickness and the weight of the color display 5 can be reduced.

### Sixth Embodiment

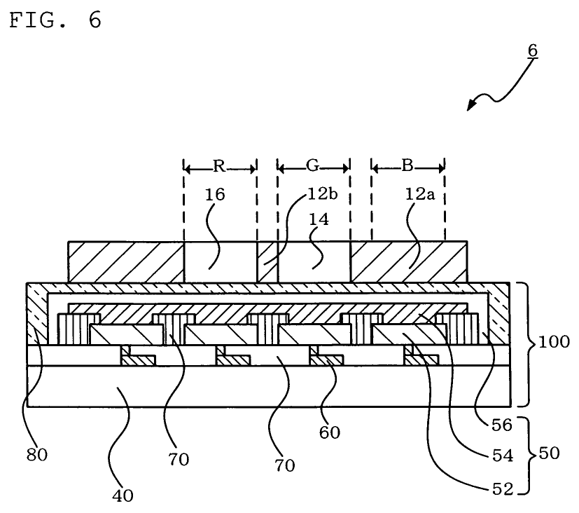

FIG. 6 is a schematic cross-sectional view showing yet another embodiment of the color display according to the invention.

A color display 6 differs from the color display 4 in that the blue color filter layers 12a and 12b, the green fluorescence conversion layer 14, and the red fluorescence conversion layer 18 are directly disposed on the barrier layer 80 of the emitting device substrate 100.

In the top emission type color display according to this embodiment, since the distance between the emitting devices 50 and the blue color filter layer 12a and the fluorescence conversion layers 14 and 16 is decreased, positioning is facilitated. Therefore, light from the emitting devices 50 can be efficiently introduced into the blue color filter layer 12a and the fluorescence conversion layers 14 and 16. Moreover, since only one substrate is used, the thickness and the weight of the color display can be reduced.

Since the TFT 60 can be easily disposed and light can be outcoupled from the opposite side of the TFT 60, the aperture ratio of the pixel can be increased, whereby the luminance of the color display 6 can be increased.

The emitting devices 50 of the above color displays 4 to 6 are preferably actively driven. A large and high-definition color display which is driven at a low voltage and does not apply load to the emitting device can be obtained by actively driving each emitting device.

Each member used in the embodiments is described below.

### 1. Color Conversion Substrate

A color conversion substrate is formed of a transparent substrate, blue color filter layer and fluorescent conversion layer, and, if necessary, a black matrix, color filter and the like.

### (1) Transparent Substrate

The transparent substrate of the invention is a substrate for supporting the organic EL display, and is preferably a flat and smooth substrate having a transmittance of 50% or more to light within visible ranges of 400 nm to 700 nm. Specific examples thereof include a glass plate and a polymer plate.

Examples of the glass plate include soda-lime glass, barium/strontium-containing glass, lead glass, aluminosilicate glass, borosilicate glass, barium borosilicate glass, and quartz. Examples of the polymer plate include polycarbonate, acrylic polymer, polyethylene terephthalate, polyethersulfide, and polysulfone.

### (2) Blue Color Filter Layer

The blue color filter layer used in the invention is disposed in the blue pixel area and between the fluorescence conversion layers of the color conversion substrate (or the resulting color display).

The blue color filter layer in the blue pixel area usually has a peak light transmittance at a wavelength of 400 to 500 nm (blue region) of 50% or more and a light transmittance at a wavelength of 500 nm or more of less than 50%. The blue color filter layer selectively transmits blue-region light from the emitting device to increase the chromatic purity of the blue light.

The side surface of the blue color filter layer which separates the fluorescence conversion layers has a light transmittance at a wavelength of 500 nm or more of preferably 50% or less, more preferably 30% or less, and still more preferably 20% or less between the fluorescence conversion layers.

The wavelength of 500 nm or more is the wavelength region of green and red fluorescence. Fluorescence can be further prevented from being mixed by adjusting the light transmittance at a wavelength of 500 nm or more to 50% or less.

Since the blue color filter layer is formed of a photosensitive resin and can be sufficiently exposed in an exposure step (light with a wavelength of 300 to 450 nm) during photolithography, a thick and minute blue color filter layer is easily obtained.

The blue color filter layer disposed between the fluorescence conversion layers has an aspect ratio (height/width) of preferably 1/2 (0.5) to 10/1 (10), and more preferably 2/3 (0.67) to 5/1 (5). If the aspect ratio is less than 1/2 (0.5), a minute blue color filter layer with a high aperture ratio may not be formed. If the aspect ratio exceeds 10/1 (10), mechanical stability may deteriorate.

The blue color filter layer disposed between the fluorescence conversion layers has a width of preferably 1 μm to 50 μm, and more preferably 5 μm to 30 μm. If the width is less than 1 μm, mechanical stability may deteriorate. If the width exceeds 50 μm, a minute blue color filter layer with a high aperture ratio may not be formed.

A preferred thickness is calculated from the preferred aspect ratio and width. The thickness is preferably 0.5 μm to 500 μm.

The surface of a plurality of blue color filter layers provided between fluorescent conversion layers may be of lattice or stripe shape. Lattice shape is preferred in view of flexibility of color arrangements.

The cross-section of blue color filter layers is generally of rectangular shape, but it can be of inverted trapezoid or T-shape.

As materials for the blue color filter layer a photosensitive resin for photolithography may be selected. Examples are photo-setting resist materials having reactive vinyl groups such as acrylic acid type, methacrylic acid type, polyvinyl cinnamate type and cyclic rubber type. These resist materials may be a liquid material or film (dry film).

The blue color filter layer may also include particles such as various blue pigments and dyes. Examples include a copper phthalocyanine pigment, indanthrone pigment, indophenol pigment, cyanine pigment, dioxazine pigment, and a combination of two or more of these pigments.

The mixing ratio of the pigments and dyes in a photosensitive resin is determined depending on the balance between the characteristics (blue chromaticity and efficiency) required for a blue pixel, blocking of light from the adjacent fluorescence conversion layers, and the thickness of the fluorescence conversion layers (embedding capability and flatness).

### (3) Fluorescent Conversion Layer

A fluorescent conversion layer is a layer having a function of converting light emitted from an emitting device to light containing a component having a longer wavelength. For example, a blue light component (in the wavelength region of 400 nm to 500 nm) is absorbed by the fluorescent conversion layer, whereby the light component is converted to green or red light having a longer wavelength.

The fluorescent conversion layer contains at least a fluorescent medium converting the wavelength of an incident light from an emitting device, and the fluorescent medium may be dispersed in a binder resin, as required.

As the fluorescent medium, organic fluorescent media and inorganic fluorescent media which are ordinarily used, such as fluorescent dyes, can be used.

In the case of converting blue, blue green or white light from an emitting device to green light, examples of a fluorescent medium therefor include coumarin dyes, such as 2,3,5,6-1H,4H-tetrahydro-8-trifluormethylquinolizino(9,9a,1-gh)coumarin (Coumarin 153), 3-(2′-benzothiazolyl)-7-diethylaminocoumarin (Coumarin 6), 3-(2′-benzimidazolyl)-7-N,N-diethylaminocoumarin (Coumarin 7); Basic Yellow 51, which is another coumarin dye; and naphthalimide dyes, such as Solvent Yellow 11 and Solvent Yellow 116.

In the case of converting rays from blue to green or white light from an emitting device to orange to red light, examples of a fluorescent dye therefor include cyanine dyes, 4-dicyanomethylene-2-methyl-6-(p-dimethylaminostyryl)-4H-pyran (DCM); pyridine dyes, such as 1-ethyl-2-(4-(p-dimethylaminophenyl)-1,3-butadienyl)-pyridinium perchlorate (Pyridine 1); rhodamine dyes, such as Rhodamine B, Rhodamine 6G, and Basic Violet 11; and oxazine dyes.

Various dyes (direct dyes, acidic dyes, basic dyes, disperse dyes and so on) can be selected if they have fluorescent properties.

The fluorescent medium that has been beforehand kneaded into a pigment resin may be used. Such pigment resins include polymethacrylic acid esters, polyvinyl chlorides, vinyl chloride vinyl acetate copolymers, alkyd resins, aromatic sulfonamide resins, urea resins, melamine resins and benzoguanamine resins.

As the inorganic fluorescent medium, an inorganic fluorescent material may be used which is formed of an inorganic compound such as a metal compound, absorbs visible light, and emits fluorescence with a wavelength longer than that of the absorbed light. The surface of the fluorescent medium may be modified with an organic substance such as a long-chain alkyl group or phosphoric acid in order to improve dispersibility in a binder resin described later, for example. The durability of the fluorescent medium layer can be further improved by using the inorganic fluorescent medium. In more detail, the following fluorescent nanocrystals are preferable since a fluorescence conversion layer with a high transparency and high conversion efficiency can be obtained.

(a) Fluorescent nanocrystal obtained by doping metal oxide with transition metal ion

A fluorescent nanocrystal obtained by doping a metal oxide such as Y₂O₃, Gd₂O₃, ZnO, Y₃Al₅O₁₂, or Zn₂SiO₄ with a transition metal ion which absorbs visible light, such as Eu²⁺, Eu³⁺, Ce³⁺, or Tb³⁺.

(b) Fluorescent Nanocrystal Obtained by Doping Metal Chalcogenide with Transition Metal Ion

A fluorescent nanocrystal obtained by doping a metal chalcogenide such as ZnS, ZnSe, CdS, or CdSe with a transition metal ion which absorbs visible light, such as Eu²⁺, Eu³⁺, Ce³⁺, Tb³⁺, or Cu²⁺. The surface of the fluorescent nanocrystal may be modified with a metal oxide such as silica or an organic substance in order to prevent removal of S, Se, or the like due to a reactive component of a binder resin described later.

(c) Fluorescent Nanocrystal which Absorbs Visible Light and Emits Fluorescence Utilizing Band Gap of Semiconductor

A semiconductor nanocrystal such as CdS, CdSe, CdTe, ZnS, ZnSe, or InP. As known from literatures such as JP-T-2002-510866, the band gap of the semiconductor nanocrystal can be controlled by reducing the particle diameter to nanometers, whereby the absorption-fluorescence wavelength can be changed. The surface of the semiconductor nanocrystal may be modified with a metal oxide such as silica or an organic substance in order to prevent removal of S, Se, or the like due to a reactive component of a binder resin described later.

For example, the surface of the CdSe particle may be covered with a shell formed of a semiconductor material (e.g. ZnS) with a higher bandgap energy. This allows a confinement effect of electrons produced in the core particle.

The above fluorescent nanocrystals may be used either individually or in combination of two or more.

A fluorescence conversion layer with a higher conversion efficiency can be obtained by using the semiconductor nanocrystal among the above fluorescent nanocrystals due to high absorption efficiency. Since the full width at half max (FWHM) of the fluorescence spectrum is reduced (i.e. the fluorescence spectrum becomes sharp; FWHM is preferably 50 nm or less) by controlling the particle diameter distribution of the semiconductor nanocrystals, a color display can be obtained in which fluorescence is prevented from being mixed into the adjacent layers and which exhibits more excellent color reproducibility.

The binder resin is preferably a material having transparency (a light transmissivity of 50% or more to visible rays). Examples of the binder resin include transparent resins (polymers) such as polyalkyl methacrylate, polyacrylate, alkylmethacrylate/methacrylic acid copolymer, polycarbonate, polyvinyl alcohol, polyvinyl pyrrolidone, hydroxyethylcellulose, and carboxymethylcellulose.

In order to separate and arrange the fluorescent medium layers two-dimensionally, a photosensitive resin to which photolithographic method can be applied is also selected. Examples thereof include acrylic acid based, methacrylic acid based, polyvinyl cinnamate based and cyclic rubber based optically curable resist materials having a reactive vinyl group. In the case of using a printing process, a printing ink (medium) in which a transparent resin is used is selected. For example, the following can be used: a monomer, oligomer or polymer of polyvinyl chloride resin, melamine resin, phenol resin, alkyd resin, epoxy resin, polyurethane resin, polyester resin, maleic acid resin or polyamide resin, or a thermoplastic or thermosetting transparent resin such as polymethyl methacrylate, polyacrylate, polycarbonate, polyvinyl alcohol, polyvinyl pyrrolidone, hydroxyethylcellulose or carboxymethylcellulose.

The fluorescence conversion layer may be formed by mixing, dispersing, or solubilizing a fluorescent medium, a binder resin, and an appropriate solvent to obtain a liquid, forming a film of the liquid on a substrate or the like using a method such as spin coating, roll coating, or casting, and embedding a desired fluorescence conversion layer between the blue color filter layers by patterning using photolithography.

In the invention, it is preferable to selectively embed the liquid between desired blue color filter layers using a printing method, particularly a screen printing method, an inkjet method, or a nozzle jet method. In this case, the contact angle of the top surface and/or the side surfaces of the blue color filter layer with the material (liquid) for the fluorescence conversion layer to be embedded can be preferably increased (300 or more) by performing fluorine (CF₄) plasma treatment or providing a fluorine coating using a fluorine-containing surfactant, a resin, or a photocatalyst layer to prevent the fluorescence conversion layer from protruding or being dented, whereby the surface of the fluorescence conversion layer can be flattened.

Since the fluorescence conversion layer is embedded only in a selected area when using the printing method, the utilization efficiency of the material for the fluorescence conversion layer is increased. In photolithography, the material for the fluorescence conversion layer is applied over the entire surface, and selected areas are exposed to remain while the other areas are discarded. Therefore, the material utilization efficiency is decreased. When forming three-color (red, blue, and green) pixels of the same size, the printing method achieves a material utilization efficiency about three times that of photolithography.

The thickness of the fluorescence conversion layer is not particularly limited insofar as the fluorescence conversion layer receives (absorbs) sufficient light from the emitting device and the fluorescence conversion function is not hindered. It is preferable that the thickness of the fluorescence conversion layer not exceed the thickness of the blue color filter layer. The thickness of the fluorescence conversion layer is preferably 0.4 μm to 499 μm, and more preferably 5 μm to 100 μm.

### (4) Color Filter

The color filter blocks excitation light of the fluorescence conversion layer and transmits fluorescence. Luminescence from the fluorescence conversion layer due to external light is suppressed by disposing such a color filter between the fluorescence conversion layer and the transparent substrate of the color conversion substrate (or the light-outcoupling side of the fluorescence conversion layer), whereby the contrast of the resulting color display can be improved. Moreover, the color purity of fluorescence from the fluorescence conversion layer can be improved.

For the color filter, the material thereof is not particularly limited. The filter is made of, for example, a dye, a pigment and a resin, or only a dye or pigment. The color filter made of a dye, a pigment and a resin may be a solid one wherein the dye and the pigment are dissolved or dispersed in the binder resin.

Preferred examples of the dye or pigment used in the color filter include perylene, isoindoline, cyanine, azo, oxazine, phthalocyanine, quinacridone, anthraquinone, and diketopyrrolo-pyrrole.

These color filter materials may be contained in the above-mentioned fluorescence conversion layer. This makes it possible to give the fluorescence conversion layer a function of converting light emitted from an emitting device and further a color filter function of improving color purity. Thus, the structure thereof becomes simple.

The color filter is formed using a method similar to that of the fluorescence conversion layer. The thickness of the color filter may be the same as that of the fluorescence conversion layer. Note that it is preferable to reduce the thickness of the color filter in order to achieve a uniform color display. For example, the thickness of the color filter is 10 nm to 5 μm, and preferably 100 nm to 2 μm.

### (5) Black Matrix

The black matrixes are disposed around between the pixels of the color conversion substrate. The black matrixes may be provided on both the top and bottom of the blue color filter layer or the fluorescence conversion layer. Since incidence and reflection of external light can be reduced by forming the black matrixes, the contrast of the resulting color display can be improved.

It is difficult to enhance the thickness and resolution of the black matrix, since a shielding material contained in a photosensitive resin usually absorbs light in the photosensitive region of the photosensitive resin (usually 300 to 450 nm) so that the photosensitive resin cannot be sufficiently exposed in the exposure step during photolithography. When forming a black matrix using a thick metal material, it is difficult to accurately etch the thick metal layer. Accordingly, since only a rough black matrix pattern (aspect ratio (thickness/width)=1/2 or less) can be formed due to low patterning accuracy, it is difficult to obtain a high-definition color conversion substrate and the resulting high-definition color display. Therefore, the thickness of the black matrix according to the invention is preferably 10 nm to 5 μm, and more preferably 100 nm to 2 μm. It is preferable to reduce the thickness of the black matrix while maintaining the light-shielding properties.

The surface of the black matrix may be of lattice or stripe shape. Lattice shape is preferred in order to enhance the contrast of a color display.

The transmittance of the black matrix to light in the visible range of 400 nm to 700 nm is preferably 10% or less and more preferably 1% or less.

As a material for the black matrix, the following metals and black pigments can be given.

Examples of metals are one or more of metals such as Ag, Al, Au, Cu, Fe, Ge, In, K, Mg, Ba, Na, Ni, Pb, Pt, Si, Sn, W, Zn, Cr, Ti, Mo, Ta and stainless. Oxides, nitrides, nitrates, sulfides, sulfates and the like of the above-mentioned metals may be used and carbon may be contained if necessary.

Examples of the black pigment include carbon black, titanium black, aniline black and a blackened mixture of the above-mentioned color filter pigments.

A solid is made by dissolving or dispersing these black pigments or the above-mentioned metallic materials in a binder resin used for a fluorescence conversion layer and is patterned by the same methods as for the fluorescence conversion layer (preferably photolithography) to form a patterned black matrix around between blue color filters and fluorescence conversion layers on the upper and/or lower sides thereof.

A film of the above material is formed on the upper side and/or the lower side of the blue color filter layer and the fluorescence conversion layer by sputtering, deposition, CVD, ion plating, electrodeposition, electroplating, chemical plating, or the like, and is patterned by photolithography or the like to form a black matrix pattern.

### 2. Emitting Device Substrate

### (1) Emitting Device

As the emitting device, an emitting device which emits visible light may be used. For example, an organic electroluminescent (EL) device, inorganic EL device, semiconductor light emitting diode, vacuum fluorescent tube, or the like may be used. Of these, an EL device using a transparent electrode on the light-outcoupling side, specifically, an organic EL device or an inorganic EL device including a reflecting electrode, an emitting layer, and a counter transparent electrode with the emitting layer placed therebetween is preferable. In particular, the organic EL device is preferred because a low-voltage high-luminance emitting device can be obtained.

As an example of the emitting device, an organic EL device will be described below.

In general, an organic EL substrate is formed of a substrate and organic EL device, and the organic EL device is formed of an emitting medium, upper electrode and lower electrode, the emitting medium being placed between the upper electrode and the lower electrode.

### (2) Supporting Substrate

The supporting substrate of the organic EL display is a member for supporting the organic EL device and the like. Therefore the substrate is preferably excellent in mechanical strength and dimension stability.

Specific examples of such a substrate include glass plates, metal plates, ceramic plates and plastic plates such as polycarbonate resins, acrylic resins, vinyl chloride resins, polyethylene terephthalate resins, polyimide resins, polyester resins, epoxy resins, phenol resins and silicon resins, fluorine-containing resins and polyether sulfone resins.

In order to avoid the invasion of moisture into the organic EL display, the substrate made of these materials is preferably subjected to a moisture proof treatment or hydrophobic treatment by forming an inorganic film or applying a fluorine-containing resin.

In particular, in order to avoid the invasion of moisture into the organic luminescent medium, the substrate preferably has a small water content and gas (steam or oxygen) permeability coefficient. Specifically, preferred water content, and steam or oxygen permeability coefficient are 0.0001% by weight or less and 1×10⁻¹³ cc·cm/cm²·sec·cmHg or less, respectively.

In the case where light is outcoupled from the side opposite to the supporting substrate, the supporting substrate is not necessarily transparent.

### (3) Emitting Medium

The luminescent medium is a medium including an organic emitting layer which can emit electroluminescence upon recombination of electrons and holes.

The thickness of the luminescent medium is not particularly limited. The thickness of the luminescent medium is preferably 5 nm to 5 μm, for example. If the thickness of the luminescent medium is less than 5 nm, luminance and durability may decrease. If the thickness of the luminescent medium exceeds 5 μm, the applied voltage increases. The thickness of the luminescent medium is more preferably 10 nm to 3 μm, and still more preferably 20 nm to 1 μm.

Such a luminescent medium may be formed by stacking the following layers on an anode.

(a) organic emitting layer

(b) hole injecting layer/organic emitting layer

(c) organic emitting layer/electron injecting layer

(d) hole injecting layer/organic emitting layer/electron injecting layer

(e) organic semiconductor layer/organic emitting layer

(f) organic semiconductor layer/electron barrier layer/organic emitting layer

(g) hole injecting layer/organic emitting layer/adhesion improving layer

Of these, the constitution (d) is preferable because of higher luminance and excellent durability.

(i) Organic Emitting Layer

Examples of luminous materials of an organic emitting layer include only one or combinations of two or more selected from p-quaterphenyl derivatives, p-quinquephenyl derivatives, benzodiazole compounds, benzimidazole compounds, benzoxazole compounds, metal-chelated oxynoid compounds, oxadiazole compounds, styrylbenzene compounds, distyrylpyrazine derivatives, butadiene compounds, naphthalimide compounds, perylene derivatives, aldazine derivatives, pyraziline derivatives, cyclopentadiene derivatives, pyrrolopyrrole derivatives, styrylamine derivatives, coumarin compounds, aromatic dimethylidyne compounds, metal complexes having an 8-quinolinol derivative as a ligand, and polyphenyl compounds.

Among these organic luminous materials, 4,4-bis(2,2-di-t-butylphenylvinyl)biphenyl (abbreviated to DTBPBBi), 4,4-bis(2,2-diphenylvihyl)biphenyl (abbreviated to DPVBi), and derivatives thereof, as aromatic dimethylidyne compounds, are more preferable.

Furthermore, it is preferred to use an organic luminescent material having a distyrylarylene skeleton or the like, as a host material together with a fluorescent dye giving intense from blue to red fluorescence, for example, a coumarin material or the like, as a dopant. More specifically, it is preferred to use the above-mentioned DPVBi or the like as a host and N,N-diphenylaminobenzene (abbreviated to DPAVB) as a dopant.

(ii) Hole Injecting Layer

Compounds having a hole mobility of 1×10⁻⁶ cm²/V·s or more measured at an applied voltage of 1×10⁴ to 1×10⁶ V/cm and an ionization energy of 5.5 eV or less are preferably used in a hole injecting layer of the luminescent medium. Such a hole injecting layer enables good hole injection into an organic emitting layer, thereby enhancing a luminance or allowing low voltage drive.

Examples of a constituent material for the hole injection layer include porphyrin compounds, aromatic tertiary amine compounds, styrylamine compounds, aromatic dimethylidine compounds, and condensed aromatic ring compounds, e.g., organic compounds such as 4,4-bis[N-(1-naphthyl)-N-phenylamino]biphenyl (abbreviated NPD) and 4,4′,4″-tris[N-(3-methylphenyl)-N-phenylamino]triphenylamine (abbreviated MTDATA).

Inorganic compounds such as p-type Si and p-type SiC are preferably used as a constituent material for the hole injection layer.

It is also preferred that an organic semiconductor layer having an electrical conductivity of 1×10⁻¹⁰ S/cm or more be formed between the above hole injecting layer and an anode, or between the above hole injecting layer and an organic emitting layer. Such an organic semiconductor layer enables better hole injection into an organic emitting layer.

(iii) Electron Injecting Layer

Compounds having an electron mobility of 1×10⁻⁶ cm²/V·s or more measured at an applied voltage of 1×10⁴ to 1×10⁶ V/cm and an ionization energy more than 5.5 eV are preferably used in an electron injecting layer. Such an electron injecting layer enables good electron injection into an organic emitting layer, thereby enhancing a luminance or allowing low voltage drive.

Examples of a constituent material for the electron injecting layer include 8-hydroxyxinoline metal complexes such as Al chelate: Alq, derivatives thereof or oxadiazole derivatives.

(iv) Adhesion Improving Layer

An adhesion improving layer is a form of the electron injecting layer. That is, it is a special layer comprising a material with good adhesion properties to a cathode among electron injecting layers. The adhesion improving layer is preferably made of 8-hydroxyxinoline metal complexes or derivatives thereof.

It is also preferred that an organic semiconductor layer with an electric conductivity of 1×10⁻¹⁰ S/cm or more be formed in contact with the above electron injecting layer. Such an organic semiconductor layer enables good electron injecting into an organic emitting layer.

### (4) Upper Electrode

An upper electrode corresponds to an anode or a cathode layer dependently on the structure of the organic EL device. In the case where the upper electrode corresponds to an anode layer, it is preferred to use a material having a large work function, for example, 4.0 eV or more, in order to make hole-injection easy. In the case where the upper electrode corresponds to a cathode layer, it is preferred to use a material having a small work function, for example, of less than 4.0 eV in order to make electron-injection easy. In the case where light is outcoupled through the upper electrode, it is necessary for the upper electrode to have transparency.

As materials for a cathode layer, for example, it is preferred to use one or a combination of two or more selected from sodium, sodium-potassium alloys, cesium, magnesium, lithium, magnesium-silver alloys, aluminum, aluminum oxide, aluminum-lithium alloys, indium, rare earth metals, mixtures of these metals and organic luminescence medium materials, mixtures of these metals and electron injecting layer materials, and so on.

In order to decrease the resistance of the upper electrode without damaging transparency, transparent electrodes such as indium tin oxide (ITO), indium zinc oxide (IZO), copper indium (CuIn), tin oxide (SnO₂), zinc oxide (ZnO) are preferably stacked on the cathode layer, or only one or combination of two or more selected from metals such as Pt, Au, Ni, Mo, W, Cr, Ta and Al is preferably added to the cathode layer.

As a constituent material of the upper electrode, at least one can be selected from the group consisting of light transmitting metal films, nondegenerate semiconductors, organic conductors, semiconductive carbon compounds and so on. Preferred organic conductors include conductive conjugated polymers, oxidizer-added polymers, reducer-added polymers, oxidizer-added low-molecular-weight molecules or reducer-added low-molecular-weight molecules.

Examples of oxidizers added to an organic conductor include Lewis acids such as iron chloride, antimony chloride and aluminum chloride. Examples of reducers added to an organic conductor include alkali metals, alkaline-earth metals, rare-earth metals, alkali compounds, alkaline-earth compounds or rare-earth compounds. Examples of conductive conjugated polymers include polyanilines and derivatives thereof, polytiophens and derivatives thereof and Lewis-acid-added amine compounds.

Preferred examples of nondegenerate semiconductors include oxides, nitrides or chalcogenide compounds.

Preferred examples of carbon compounds include amorphous C, graphite or diamond like C.

Examples of inorganic semiconductors include ZnS, ZnSe, ZnSSe, MgS, MgSSe, CdS, CdSe, CdTe or CdSSe.

The thickness of the upper electrode is preferably determined considering its sheet resistance or the like. For example, the thickness of the upper electrode is preferably in the range of 50 nm to 5000 nm, more preferably 100 nm to 500 nm. Such a thickness allows a uniform thickness distribution and light transmission of 60% or more of EL emission as well as a sheet resistance of the upper electrode of 15 Ω/□ or less, more preferably 10 Ω/□ or less.

### (5) Lower Electrode

A lower electrode corresponds to an anode or a cathode layer dependently on the structure of the organic EL device. In the case where the lower electrode corresponds to an anode layer, materials for the lower electrode include only one or combinations of two or more selected from indium tin oxide (ITO), indium zinc oxide (IZO), copper indium (CuIn), tin oxide (SnO₂), zinc oxide (ZnO), antimony oxide (Sb₂O₃, Sb₂O₄, Sb₂O₅), aluminum oxide (Al₂O₃) and so on.

It is not necessary for materials of the under electrode to have transparency when luminescence is outcoupled from the upper electrode side. It is preferably made rather from light-absorbing conductive materials. This structure enhances the display contrast of organic EL display. In this case, preferable light-absorbing conductive materials include semiconductive carbonate materials, colored organic compounds, combinations of the above reducers and oxidizers, and colored conductive oxide (transition metal oxides such as VOx, MoOx, WOx etc.)

The lower electrode may be made from reflective materials. This structure efficiently outcouples light from organic EL display. In this case, preferable light reflective materials include materials having a high refractive index such as the metal materials described above for the black matrix, titanium oxide, magnesium oxide and magnesium sulfate.

The thickness of the lower electrode is not particularly limited as well as the upper electrode. However, it is preferably in the range of, for example, 10 nm to 1000 nm, more preferably 10 to 200 nm.

### (6) Inter-Insulator (Including Flattening Layer)

An inter-insulator in an organic EL display is formed near or around an emitting medium. The inter-insulator is used for high resolution of a whole organic EL display, and for prevention of short circuits between under and upper electrodes. In the case that an organic EL device is driven by TFTs, the inter-insulator is also used for protection of the TFTs and as a base for forming an under electrode on a flat plane.

In the invention the inter-insulator is provided to bury gaps between electrodes formed separately disposed per pixel. That is, the inter-insulator is disposed along boundaries between pixels.

Examples of materials for the inter-insulator usually include acrylic resins, polycarbonate resins, polyimide resins, fluorinated polyimide resins, benzoguanamine resins, melamine resins, cyclic polyolefins, Novolak resins, polyvinyl cinnamates, cyclic rubbers, polyvinyl chloride resins, polystyrenes, phenol resins, alkyd resins, epoxy resins, polyurethane resins, polyester resins, maleic acid resins, and polyamide resins.

In the case where the inter-insulator is made of an inorganic oxide, preferred inorganic oxides include silicon oxide (SiO₂ or SiOₓ), aluminum oxide (Al₂O₃ or AlOₓ) titanium oxide (TiO₃ or TiOₓ), yttrium oxide (Y₂O₃ or YOₓ), germanium oxide (GeO₂ or GeOₓ), zinc oxide (ZnO), magnesium oxide (MgO), calcium oxide (CaO), boric acid (B₂O₃), strontium oxide (SrO), barium oxide (BaO), lead oxide (PbO), zirconia (ZrO₂), sodium oxide (Na₂O), lithium oxide (Li₂O), and potassium oxide (K₂O).

The value x in the above inorganic compounds is in the range of 1≦x≦3.

In the case where the inter-insulator requires heat-resistance, it is preferred to use acrylic resins, polyimide resins, fluorinated polyimides, cyclic olefins, epoxy resins, or inorganic oxides.

If the inter-insulator is organic, it can be processed into a desired pattern by introducing a photosensitive group thereto and using photolithography, or can be formed into a desired pattern by printing.

The thickness of the inter-insulator depends on the resolution of display, or unevenness of other members to be combined with the organic EL device, and is preferably 10 nm to 1 mm. This is because such a thickness can make the unevenness of TFTs and the like sufficiently flat. The thickness of the inter-insulator is more preferably 100 nm to 100 μm, and still more preferably 100 nm to 10 μm.

### (7) Barrier Film

A brrier film is preferably further provided on the organic EL substrate. Since an organic EL device is easily deteriorated by moisture or oxygen, the barrier film blocks them.

Specifically, transparent inorganic materials such as SiO₂, SiOₓ, SiOₓN_{y}, Si₃N₄, Al₂O₃, AlOₓN_{y}, TiO₂, TiOₓ, SiAlOₓN_{y}, TiAlOₓ, TiAlOₓN_{y}, SiTiOₓ and SiTiOₓN_{y} are preferable.

In the case of using such transparent inorganic materials, the film is preferably formed at a low temperature (100° C. or lower) and a slow film-forming speed in order that an organic EL device is not deteriorated. Specifically, methods such as sputtering, vapor deposition or CVD are preferred.

These transparent inorganic materials are preferably amorphous since the amorphous films have a high effect of brocking moisture, oxygen, low molecular monomers and so on and suppress the deterioration of an organic EL device.

The thickness of the barrier film is preferably 10 nm to 1 mm. If the thickness of the barrier film is less than 10 nm, a large amount of water or oxygen may permeate the barrier film. If the thickness of the barrier film exceeds 1 mm, the thickness of the display may not be reduced due to the thick barrier film. Therefore, the thickness of the barrier film is more preferably 10 nm to 100 μm.

### 3. Adhesive Layer

The adhesive layer is a layer used to bond the organic EL substrate and the color conversion substrate. The adhesive layer may be disposed around the display section, or may be disposed over the entire surface.

It is preferable to form the adhesive layer using a UV-curable resin, a visible light curable resin, a heat-curable resin, or an adhesive using these resins. Specific examples include commercially available products such as Luxtrak LCR0278, 0242D (manufactured by Toagosei Co., Ltd.), TB3113 (epoxy type, manufactured by Three Bond Co., Ltd.), and Benefix VL (acrylic type, manufactured by Adell Corporation).

### EXAMPLES

### Example 1

### (1) Formation of TFT Substrate

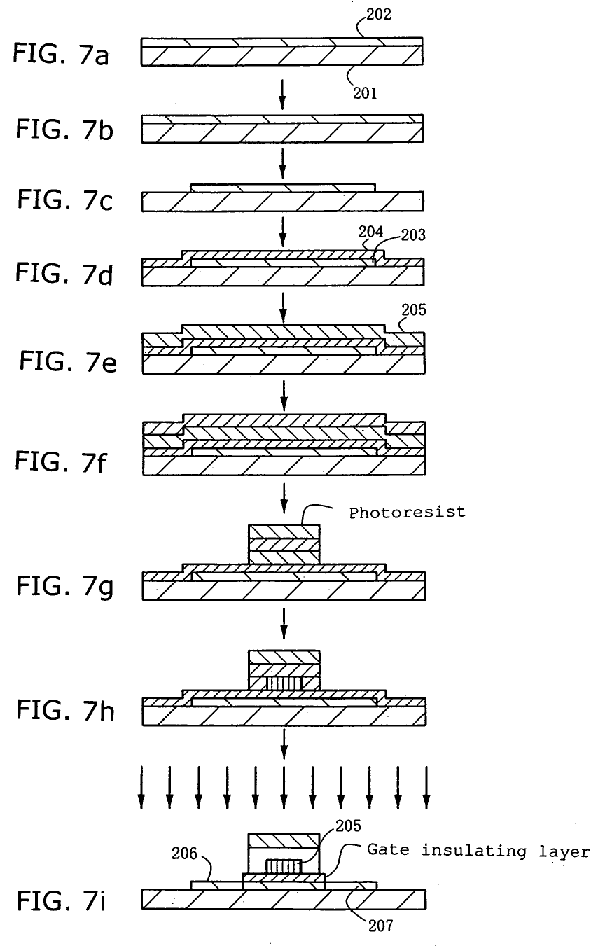

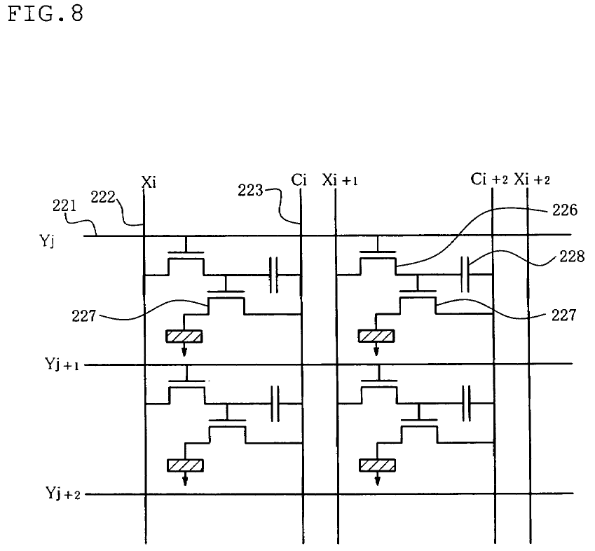

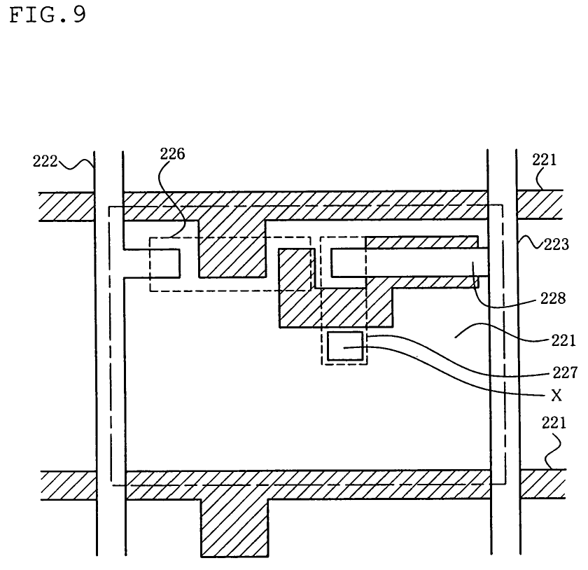

FIGS. 7(a) to (i) are views showing polysilicon TFT formation steps. FIG. 8 is a circuit diagram showing an electric switch connection structure including a polysilicon TFT, and FIG. 9 is a planar perspective view showing an electric switch connection structure including a polysilicon TFT.

An α-Si layer 202 was formed on a glass substrate 201 (OA2 glass manufactured by Nippon Electric Glass Co., Ltd.) having dimensions of 112×143×1.1 mm by a method such as low pressure chemical vapor deposition (LPCVD) (FIG. 7(a)). Then, crystallization annealing was performed by applying an excimer laser such as a KrF (248 nm) laser to the α-Si layer 202 to form polysilicon (FIG. 7(b)). The polysilicon was patterned in the shape of islands by photolithography (FIG. 7(c)). An insulating gate material 204 was stacked on the surfaces of the island-shaped polysilicon 203 and the substrate 201 by chemical vapor deposition (CVD) or the like to form a gate oxide insulating layer 204 (FIG. 7(d)). After forming a gate electrode 205 by deposition or sputtering (FIG. 7(e)), the gate electrode 205 was patterned and anodic oxidation was performed (FIGS. 7(f) to 7(h)). Then, doped regions (active layer) were formed by ion doping (ion implantation) to form a source 206 and a drain 207 to obtain a polysilicon TFT (FIG. 7(i)). The gate electrode 205 (and scan electrode 221 and bottom electrode of capacitor 228 shown in FIG. 8) was formed from Al, and the source 206 and the drain 207 of the TFT were of n⁺-type.

After forming an interlayer dielectric (SiO₂) having a thickness of 500 nm on the active layer by a CRCVD method, a signal electrode 222, a common electrode 223, and a capacitor upper electrode (Al) were formed, a source electrode of a second transistor (Tr2) 227 was connected with the common electrode, and the drain of a first transistor (Tr1) 226 was connected with the signal electrode (FIGS. 8 and 9). The TFT and the electrode were connected by appropriately opening the interlayer dielectric SiO₂ by wet etching using hydrofluoric acid.

Then, Al and IZO (indium zinc oxide) were deposited by sputtering to thicknesses of 2000 angstroms and 1300 angstroms, respectively. A positive-type resist (“HPR204” manufactured by Fuji Photo Film Arch Co., Ltd.) was applied to the substrate by spin coating, and ultraviolet rays were applied through a photomask for forming a 100 μm×320 μm dot-shaped pattern. The resist was then developed using a tetramethylammonium hydroxide (TMAH) developer and baked at 130° C. to obtain a resist pattern.

The exposed IZO was etched using an IZO etchant containing 5% oxalic acid, and the Al was etched using an aquous solution containing phosphoric acid/acetic acid/nitric acid. The resist was treated with a stripper containing ethanolamine as the major component (“106” manufactured by TOKYO OHKA KOGYO CO., LTD.) to obtain a Al/IZO pattern (lower electrode: anode).

In this step, the second transistor Tr2 227 and the lower electrode 201 were connected through an opening X (FIG. 9).

As a second interlayer dielectric, a black negative-type resist (“V259BK” manufactured by Nippon Steel Chemical Co., Ltd.) was applied by spin coating, irradiated with ultraviolet rays, and developed using a tetramethylammonium hydroxide (TMAH) developer. The resulting resist was baked at 220° C. to form an interlayer dielectric of an organic film which covered the edge of the Al/IZO (thickness: 1 μm, IZO opening: 90 μm×310 μm) (not shown).

### (2) Fabrication of Organic EL Device

The substrate on which the interlayer insulator was formed was subjected to ultrasonic cleaning in pure water and isopropyl alcohol, dried by air blowing, and subjected to UV cleaning.

The TFT substrate was transferred to an organic deposition device (manufactured by ULVAC, Inc.) and secured on a substrate holder. Individual molybdenum heating boats were charged in advance with 4,4′,4″-tris[N-(3-methylphenyl)-N-phenylamino]triphenylamine (MTDATA) and 4,4′-bis[N-(1-naphthyl)-N-phenylamino]biphenyl (NPD) as a hole injecting material, 4,4′-bis(2,2-diphenylvinyl)biphenyl (DPVBi) as a host of an emitting material, 1,4-bis[4-(N,N-diphenylaminostyrylbenzene).] (DPAVB) as a dopant, and tris(8-quinolinol)aluminum (Alq) and Li as an electron injecting material and a cathode. An IZO (mentioned above) target was placed in another sputtering vessel as a cathode lead electrode.

After reducing the pressure inside the vacuum chamber to 5×10⁻⁷ torr, the layers from the hole injecting layer to the cathode were stacked as described below without breaking the vacuum.

As the hole injecting layer, MTDATA was deposited to a thickness of 60 nm at a deposition rate of 0.1 to 0.3 nm/sec and NPD was deposited to a thickness of 20 nm at a deposition rate of 0.1 to 0.3 nm/sec. As the emitting layer, DPVBi and DPAVB were co-deposited to a thickness of 50 nm at deposition rates of 0.1 to 0.3 nm/sec and 0.03 to 0.05 nm/sec, respectively. As the electron injecting layer, Alq was deposited to a thickness of 20 nm at a deposition rate of 0.1 to 0.3 nm/sec. As the cathode, Alq and Li were co-deposited to a thickness of 20 nm at deposition rates of 0.1 to 0.3 nm/sec and 0.005 nm/sec, respectively.

Then, the substrate was transferred to the sputtering vessel, and IZO was deposited to a thickness of 200 nm at a film-formation rate of 0.1 to 0.3 nm/sec as the lead electrode of the cathode to obtain an organic EL device.

### (3) Formation of Barrier Film and Organic EL Substrate

Next, as a barrier film, a transparent inorganic film SiOₓN_{y} (O/O+N=50%: atomic ratio) was deposited on the IZO electrode of an organic EL device by low-temperature CVD in a thickness of 200 nm. An organic EL substrate was thus obtained.

### (4) Production of Color Conversion Substrate

V259BK (manufactured by Nippon Steel Chemical Co., Ltd.) as the material for a black matrix was applied by spin coating to a supporting substrate (transparent substrate) (OA2 glass manufactured by Nippon Electric Glass Co., Ltd.) having dimensions of 102×133×1.1 mm. Then, ultraviolet rays were applied through a photomask which was patterned so that a lattice-shaped pattern was formed. The material was developed using a 2% sodium carbonate aqueous solution and baked at 200° C. to obtain a black matrix pattern (thickness: 1.0 μm). The black matrix had a light transmittance at a wavelength of 400 nm to 700 nm (visible region) of 1% or less. The line width of the lattice-shaped pattern was 30 μm. The opening had a size of 80 μm×300 μm (aperture ratio was 66%).

V259G (manufactured by Nippon Steel Chemical Co., Ltd.) as the material for a green color filter was applied by spin coating. Then, ultraviolet rays were applied to the material through a photomask so that 320 rectangular stripe patterns (100-μm line and 230-μm gap) were obtained. The material was then developed using a 2% sodium carbonate aqueous solution and baked at 200° C. to obtain a green color filter pattern (thickness: 1.5 μm).

V259R (manufactured by Nippon Steel Chemical Co., Ltd.) as the material for a red color filter was applied by spin coating. Then, ultraviolet rays were applied to the material through a photomask so that 320 rectangular stripe patterns (100-μm line and 230-μm gap) were obtained. The material was then developed using a 2% sodium carbonate aqueous solution and baked at 200° C. to obtain a red color filter pattern (thickness: 1.5 μm) adjacent to the green color filter.

3 wt % (in solid content) of a copper phthalocyanine pigment (Pigment Blue 15:6) and 0.3 wt % (in solid content) of a dioxazine violet pigment (Pigment Violet 23) as the material for a blue color filter layer were dispersed in VPA204/P5.4-2 (manufactured by Nippon Steel Chemical Co., Ltd.). After applying the ink to the substrate by spin coating, ultraviolet rays were applied to the ink through a photomask which was patterned so that stripe-shaped blue pixels and layers (also called partition wall or bank) separating the fluorescence conversion layers were formed at the same time. The ink was then developed using a 2% sodium carbonate aqueous solution and baked at 200° C. to form a blue color filter layer.

The line width of the layer including the blue pixel was 130 μm, the line width of the layer separating the fluorescence conversion layers was 20 μm, and the thickness was 15 μm. The side surfaces of the blue color filter layer adjacent to the fluorescence conversion layers had a light transmittance at a wavelength of 500 nm or more of 20% or less between the fluorescence conversion layers.

The transmittance of the side surfaces of the blue color filter layer adjacent to the fluorescence conversion layers is calculated from the transmittance and the thickness of the pixel part of the blue color filter layer and the line width of the layer separating the fluorescence conversion layers. Specifically, the transmittance is converted into absorbance, and the absorbance is calculated proportional to the thickness and converted into transmittance.

A Cu-doped ZnSe nanocrystal was synthesized as the material for a green fluorescence conversion layer referring to J. Am. Chem. Soc., 2005, 127, 17586. The nanocrystals were dispersed in V259PA (manufactured by Nippon Steel Chemical Co., Ltd.) in an amount of 20 wt % (in solid content). The mixture was provided between blue color filter layers using a piezoelectric inkjet device. The material was irradiated with ultraviolet rays and baked at 200° C. to obtain a green fluorescence conversion layer embedded between the blue color filter layers. The thickness of the green fluorescence conversion layer was 13 μm.

An InP/ZnS semiconductor nanocrystal was synthesized as the material for a red fluorescence conversion layer referring to J. Am. Chem. Soc., 2005, 127, 11364. The nanocrystals were dispersed in V259PA (manufactured by Nippon Steel Chemical Co., Ltd.) in an amount of 20 wt % (in solid content). The mixture was provided between other blue color filter layers using a piezoelectric inkjet device. The material was irradiated with ultraviolet rays and baked at 200° C. to obtain a red fluorescence conversion layer embedded between the blue color filter layers. The thickness of the red fluorescence conversion layer was 13 μm.

A color conversion substrate was thus obtained.

### (5) Bonding Upper and Lower Substrates

A photo/heat-curable adhesive (TB3113 manufactured by Three Bond Co., Ltd.) was applied to the entire surface of the resulting color conversion substrate. The organic EL substrate was positioned on the color conversion substrate so that light from the organic EL device was received by the fluorescence color conversion layer or the blue color filter layer (pixel part) of the color conversion substrate. After applying light to the adhesive from the color conversion substrate side, the adhesive was heated at 80° C. to bond the substrates to obtain an organic EL color display.

### (6) Evaluation of Characteristics of Organic EL Display

A DC voltage of 7 V was applied between the lower electrode (IZO/Al) and the upper electrode (IZO) of the organic EL display (lower electrode: (+), upper electrode: (−)). As a result, light was emitted from the intersection (pixel) of the electrodes.

The chromaticity was measured using a chromameter (CS100 manufactured by Minolta). The CIE chromaticity coordinates of the blue color filter (CF) (blue pixel) were X=0.13 and Y=0.08, the CIE chromaticity coordinates of the green fluorescence conversion layer/green color filter (green pixel) were X=0.20 and Y=0.69, and the CIE chromaticity coordinates of the red fluorescent material layer/red color filter (red pixel) were X=0.67 and Y=0.33. The NTSC ratio was 99%. A color display with high color reproducibility was obtained.

### Comparative Example 1

### Black Matrix Separation Layer

The formation of a black matrix shielding layer (V259BK manufactured by Nippon Steel Chemical Co., Ltd.) with a thickness of 15 μm was attempted in the same way as in Example 1 instead of the separation layer formed of the blue color filter layer. However, a black matrix pattern with a line width of 20 μm could not be formed due to insufficient UV transmittance. Therefore, a color conversion substrate and color display with the same definition as that of Example 1 could not be formed.

### Comparative Example 2

### Transparent Separation Layer

A transparent separation layer was formed in Example 1 instead of the separation layer formed of the blue color filter layer. After forming the red color filter, VPA204/P5.4-2 (manufactured by Nippon Steel Chemical Co., Ltd.) as the material for the transparent separation layer (partition wall or bank) was applied by spin coating on a substrate. Then, ultraviolet rays were applied to the material through a photomask so that a stripe-shaped separation layer was formed. The material was then developed using a 2% sodium carbonate aqueous solution and baked at 200° C. to form a transparent separation layer.

The line width of the layer separating the fluorescence conversion layers was 20 μm, and the thicknesses was 15 μm.

3 wt % (in solid content) of a copper phthalocyanine pigment (Pigment Blue 15:6) and 0.3 wt % (in solid content) of a dioxazine violet pigment (Pigment Violet 23) as the material for a blue color filter layer were dispersed in VPA204/P5.4-2 (manufactured by Nippon Steel Chemical Co., Ltd.). After applying the ink to the substrate by spin coating, ultraviolet rays were applied to the ink through a photomask which was patterned so that a stripe-shaped blue pixel was formed. The ink was then developed using a 2% sodium carbonate aqueous solution and baked at 200° C. to form a blue color filter layer between the separation layers.

Thereafter, a color conversion substrate and a color display were formed according to the same procedure as in Example 1. In Comparative Example 2, the step of forming the transparent separation layer is required in addition to the steps of Example 1 when forming the color conversion substrate.

A DC voltage of 7 V was applied between the lower electrode (IZO/Al) and the upper electrode (IZO) of the organic EL display (lower electrode: (+), upper electrode: (−)). As a result, light was emitted from the intersection (pixel) of the electrodes.

The chromaticity was measured using a chromameter (CS100 manufactured by Minolta). The CIE chromaticity coordinates of the blue color filter (CF) (blue pixel) were X=0.13 and Y=0.08, the CIE chromaticity coordinates of the green fluorescence conversion layer/green color filter (green pixel) were X=0.23 and Y=0.66, and the CIE chromaticity coordinates of the red fluorescent material layer/red color filter (red pixel) were X=0.67 and Y=0.33. The NTSC ratio was 91%. A color display with color reproducibility lower than that of Example 1 was obtained. The reason therefor is considered to be as follows. When causing the green fluorescence conversion layer to emit light, green light passed through the separation layer in the side surface direction and excited the red conversion layer, whereby red light from the red fluorescence conversion layer was mixed in.

### INDUSTRIAL APPLIABILITY

The color display using the color conversion substrate according to the invention is used for consumer and industrial displays such as displays for portable display terminals, car-mounted displays such as displays for car navigation systems and instrumental panels, personal computers for office automation (OA), TVs, and displays for factory automation (FA). In particular, the color display is used for thin and flat monocolor, multicolor, or full-color displays and the like.

What is claimed is:

1. A color conversion substrate comprising:
a transparent substrate; and
a plurality of blue color filter layers and a plurality of fluorescence conversion layers provided on the transparent substrate;
part of the blue color filter layers separating the fluorescence conversion layers.

2. The color conversion substrate according to claim 1, wherein the fluorescence conversion layers include a green fluorescence conversion layer and a red fluorescence conversion layer.

3. The color conversion substrate according to claim 1, wherein the blue color filter layer which separates the fluorescence conversion layers has a light transmittance between the fluorescence conversion layers at a wavelength of 500 nm or more of 50% or less.

4. The color conversion substrate according to claim 1, wherein black matrixes are provided between the blue color filter layers and the fluorescence conversion layers.

5. The color conversion substrate according to claim 1, comprising, between the fluorescence conversion layers and the transparent substrate, color filters which block excitation light for the fluorescence conversion layers and transmit fluorescence from the fluorescence conversion layers.

6. The color conversion substrate according to claim 1, wherein the fluorescence conversion layers include a fluorescent nanocrystal.

7. The color conversion substrate according to claim 6, wherein the fluorescent nanocrystal is a semiconductor nanocrystal.

8. A color display comprising:
the color conversion substrate according to claim 1; and
an emitting device substrate facing the color conversion substrate and emitting a blue light component.

9. A color display comprising:
the color conversion substrate according to claim 1; and
emitting devices facing a blue color filter layer and the fluorescence conversion layers of the color conversion substrate and emitting a blue light component.

10. A color display comprising on a substrate at least a first pixel in which a first emitting device and a blue color filter layer are formed in that order, a second pixel in which a second emitting device and a first fluorescence conversion layer are formed in that order, and a third pixel in which a third emitting device and a second fluorescence conversion layer are formed in that order, the first fluorescence conversion layer and the second fluorescence conversion layer being separated by a blue color filter layer.

11. The color display according to claim 8, wherein emitting devices are actively driven.

12. The color display according to claim 9, wherein the emitting devices are actively driven.

13. The color display according to claim 10, wherein the emitting devices are actively driven.

14. A method of producing the color conversion substrate according to claim 1, the method comprising:
forming a plurality of blue color filter layers on a transparent substrate; and
selectively forming a plurality of fluorescence conversion layers between the blue color filter layers using a printing method.

15. The method according to claim 14, wherein the printing method is a screen printing method, an inkjet method, or a nozzle jet method.
